(19) United States
(12) Patent Application Publication
(10) Pub. No.: US 2005/0217444 A1
(43) Pub. Date: Oct. 6, 2005

(54) Guide and clamp device for positioning workpieces

(76) Inventor: Tien-Min Li, Daya Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/811,818

(22) Filed: Mar. 30, 2004

(51) Int. Cl. B26D 7/02

(52) U.S. Cl. 83/454

(57) ABSTRACT

A guide and clamp device includes a base board having two guide boards on the base board so as to define a support area therebetween and the workpiece is to be put on the support area. Each guide board includes a first guide surface, a second guide surface and a third guide surface relative to a longitudinal axis of the support area. A blade groove is defined through the two guide boards and oriented to be perpendicular to a longitudinal axis of the support area. A clamping member is connected to the device and includes a pressing member for positioning the workpiece. A pawl pivotably connected to the clamping member so quickly lock and release the pressing member.

### FIELD OF THE INVENTION

The present invention relates to a device for conveniently positioning a workpiece at different angles and clamping the workpiece firmly and quickly.

### BACKGROUND OF THE INVENTION

A conventional guide device for positioning the workpiece at different angles generally includes three blocks protruding on two sides of the device. Two of the three blocks at each of the two sides respectively include two respective inclined grooves at 30 degrees and 45 degrees. The two respective grooves of the two groups of the blocks are located correspondingly. A main groove is defined in the center portion of the device and oriented to be perpendicular to the surface for positioning the workpiece such that a blade of a tool is inserted in the main groove to cut the workpiece. The device is fixed to the worktable by bolts extending through the worktable and fixed to an underside of the device. It is noted that the workpiece is simply positioned by a clamping member and tends to slide during being cut. The blade is damaged if the grooves are too narrow to restrict the movement of the blade. The blade is bent and shakes if the groove are too wide, and it takes a lot of time to put the blade in the grooves. Besides, there are recessed areas in the device and wider than that of the clamping member which could spins into the recessed areas.

The present invention intends to provide a guide and clamp device that includes several guide surfaces and a clamping device which can clamp the workpiece within a short period of time.

### SUMMARY OF THE INVENTION

The present invention relates to a guide and clamp device for positioning a workpiece and comprises a base board having two guide boards between which a support area is defined such that the workpiece is put on the support area. Each guide boards includes a first guide surface, a second guide surface and a third guide surface relative to a longitudinal axis of the support area. A blade groove is defined through the two guide boards and oriented to be perpendicular to a longitudinal axis of the support area for a tool blade inserted therein. The clamp device is connected to the base board and uses a pawl to quickly position a pressing member which presses the workpiece.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the guide and clamp device of the present invention;

FIG. 2 is a side view of the guide and clamp device of the present invention;

FIG. 3 is a top view to show the guide and clamp device of the present invention;

FIG. 4 is an exploded view to show the guide and clamp device of the present invention;

FIG. 5 is a cross sectional view to show that the pawl is engaged with the pressing member, and

FIG. 6 is a cross sectional view to show that the pawl is pivoted to disengaged with the pressing member.

### DETAILED DESCRIPTION OF THE PREFERRED EMBODIMENT

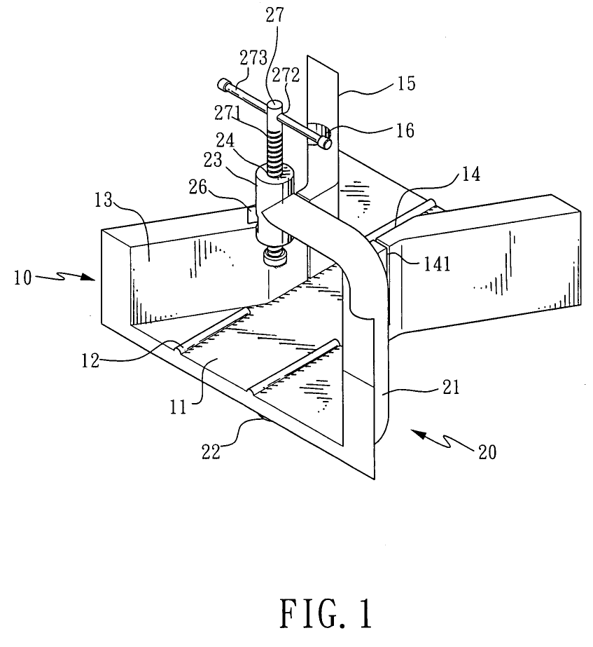

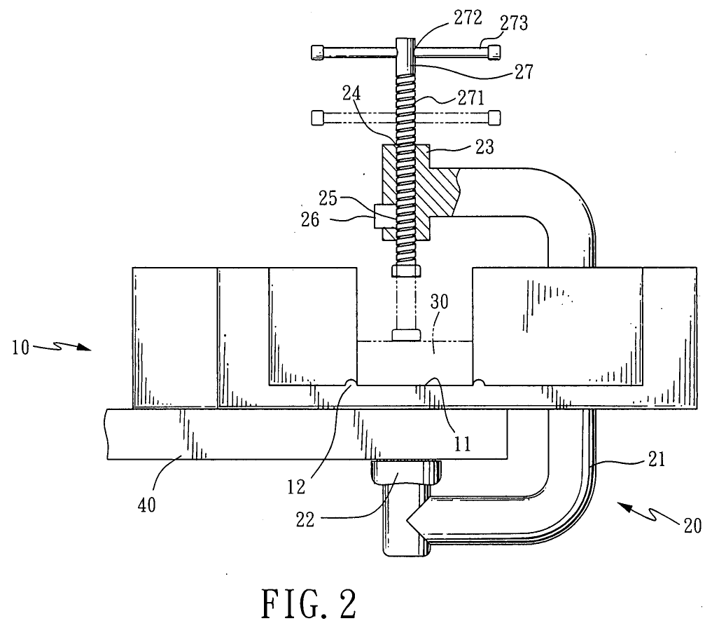

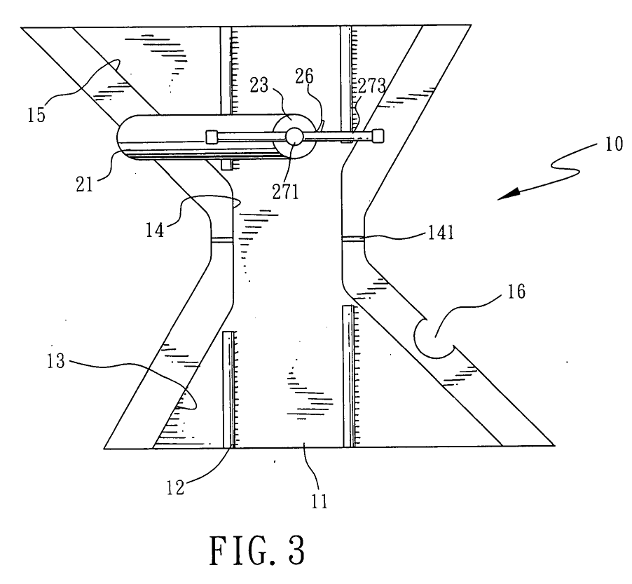

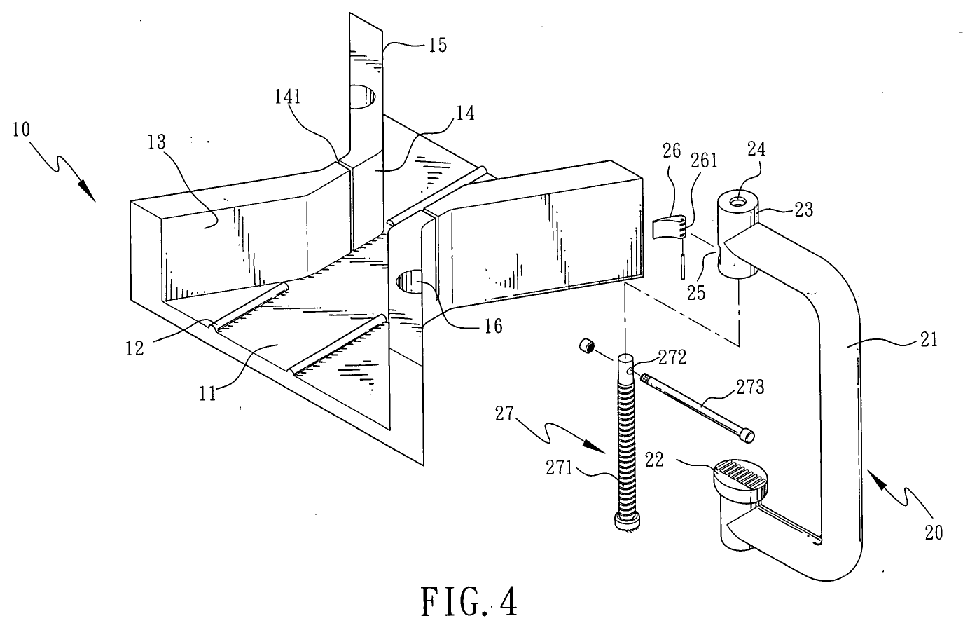

Referring to FIGS. 1 to 4, the guide and clamp device of the present invention comprises a base board 10 which is fixed to a work table 40 and two guide boards are located on the base board 10 so as to define a support area 111 between the guide boards. Each guide board includes a first guide surface 13, a second guide surface 14 and a third guide surface 15 relative to a longitudinal axis of the support area 11 such that a workpiece 30 as shown in FIG. 2 can be put on the support area 11 and guided on either of the three guide surfaces 13, 14 and 15. The first guide surface 13 and the third guide surface 15 are oriented respectively at 30 degrees and 45 degrees relative to the longitudinal axis of the support area 11. The second guide surface 14 is parallel to the longitudinal axis of the support area 11. Two guide flanges 12 extend from a top surface of the support area 11 and are parallel to the longitudinal axis of the support area 11 such that the workpiece 30 may be guided between the two guide flanges 12. A blade groove 141 is defined through the two guide boards and cut through the second guide face 14. The blade groove 141 is oriented to be perpendicular to a longitudinal axis of the support area 11 so that the tool blade (not shown) is movably inserted in the blade groove 141.

A clamping device 20 includes a U-shaped frame 21 which has one section thereof engaged with one of two recesses 16 defined in an outside of the two guide boards, a positioning disk 22 connected to a first end of the U-shaped frame 21 so as to contact an underside of the base board 11 and a cylindrical tube 23 connected to a second end of the U-shaped frame 21. The two recesses 16 are located at different sides relative to the support area 11 so that the clamping device 20 can be adjusted its positions to position the workpiece 30 as desired. A pressing member 27 has first threads 271 defined in an outer periphery thereof and movably extends through a through hole 24 defined in the cylindrical tube 23. The through hole 24 includes a smooth inner surface and an inner diameter of the through hole 24 is larger than an outer diameter of the pressing member 27 so that the pressing member 27 can be quickly moved through the through hole 24.

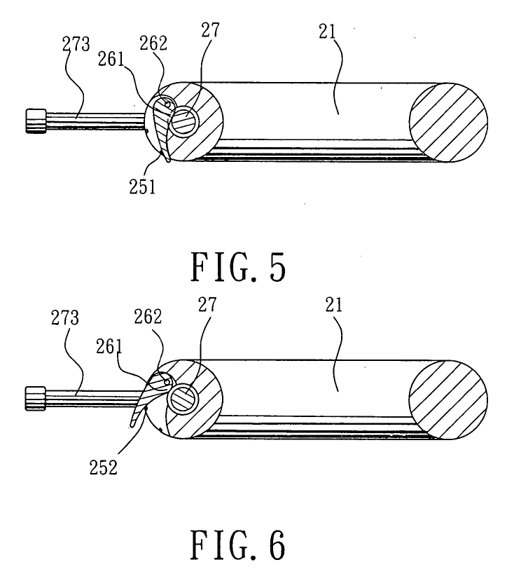

A side hole 25 is defined through the cylindrical tube 23 and communicates with the through hole 24. A pawl 26 is pivotably engaged with the side hole 25 and includes second threads 261 which are engaged with the first threads 271 when the pawl 26 is pivoted to its lock position 251 as shown in FIG. 5. A transverse hole 272 is defined through a top end of the pressing member 27 and a bar 273 extends through the transverse hole 272 so that a user may operate the bar 273 as a handle to rotate the bar 273. An enlarged end is connected to a lower end of the pressing member 27 and includes a flat surface so as to be pressed on the workpiece 30. The pawl 26 may have a cam-shaped head which contacts the pressing member 27 and a pin eccentrically extends through the cam-shaped head and is engaged with the side hole 25 so that the pawl 26 can be conveniently engaged with the pressing member 27. As shown in FIG. 6, when the pawl 26 is pivoted to its unlock position 252, the pressing member 27 can be quickly moved through the through hole 24. The pin can also be extended through a center of the cam-shaped head of the pawl 26 as long as the pawl 26 can be engaged with the pressing member 27.

While we have shown and described the embodiment in accordance with the present invention, it should be clear to those skilled in the art that further embodiments may be made without departing from the scope of the present invention.

1. A guide and clamp device comprising:
a base board and two guide boards located on the base board so as to define a support area between the guide boards, each guide board including a first guide surface, a second guide surface and a third guide surface relative to a longitudinal axis of the support area, a blade groove defined through the two guide boards and being oriented to be perpendicular to a longitudinal axis of the support area.

2. The device as claimed in claim 1, wherein the first guide surface and the third guide surface are oriented respectively at 30 degrees and 45 degrees relative to the longitudinal axis of the support area, and the second guide surface being parallel to the longitudinal axis of the support area.

3. The device as claimed in claim 1, wherein the support area includes two guide flanges extending from a top surface thereof and being parallel to the longitudinal axis of the support area.

4. The device as claimed in claim 1 further comprising a clamping device which includes a frame, a positioning disk connected to a first end of the frame so as to contact an underside of the base board and a cylindrical tube connected to a second end of the frame, a pressing member movably extending through a through hole defined in the cylindrical tube.

5. The device as claimed in claim 4, wherein each of the guide boards has a recess and a section of the frame is received in one of the two recesses.

6. The device as claimed in claim 4, wherein a side hole defined through the cylindrical tube and communicates with the through hole, a pawl pivotably engaged with the side hole and contacting the pressing member.

7. The device as claimed in claim 4, wherein the through hole includes a smooth inner surface and an inner diameter of the through hole is larger than an outer diameter of the pressing member.

8. The device as claimed in claim 6, wherein the pressing member includes first threads defined in an outer periphery thereof and the pawl includes second threads which are engaged with the first threads.

9. The device as claimed in claim 6, wherein the pawl includes a cam-shaped head which contacts the pressing member.

10. A clamping device comprising:
a frame, a positioning disk connected to a first end of the frame so as to be adapted to contact an underside of a base board and a cylindrical tube conn ected to a second end of the frame, a pressing member movably extending through a through hole defined in the cylindrical tube.

11. The device as claimed in claim 10, wherein a side hole defined through the cylindrical tube and communicates with the through hole, a pawl pivotably engaged with the side hole and contacting the pressing member.

12. The device as claimed in claim 10, wherein the through hole includes a smooth inner surface and an inner diameter of the through hole is larger than an outer diameter of the pressing member.

13. The device as claimed in claim 11, wherein the pressing member includes first threads defined in an outer periphery thereof and the pawl includes second threads which are engaged with the first threads.

14. The device as claimed in claim 11, wherein the pawl includes a cam-shaped head which contacts the pressing member.
